(19) United States
(12) Patent Application Publication
(10) Pub. No.: US 2007/0199017 A1
(43) Pub. Date: Aug. 23, 2007

(54) Intelligent automated method and system for optimizing the value of the sale and/or purchase of certain advertising inventory

(76) Inventors: Gary S. Cozen, Pittsburgh, PA (US); Alan F. Mandel, Pittsburgh, PA (US); Jon Gluck, Rye, NY (US); David M. Edison, Pittsburgh, PA (US)

Correspondence Address: MEYER UNKOVIC & SCOTT LLP, 1300 OLIVER BUILDING, PITTSBURGH, PA, 15222, US

(21) Appl. No.: 11/709,066

(22) Filed: Feb. 21, 2007

Related U.S. Application Data
(60) Provisional application No. 60/775,421, filed on Feb. 21, 2006.

(51) Int. Cl. H04N 7/10; H04N 7/025; G06F 13/00; H04N 5/445; G06F 3/00

(52) U.S. Cl. 725/35; 725/34; 725/46

(57) ABSTRACT

The present invention creates an intelligent automated system that enables media outlets to optimize the value of their advertising inventory. It also enables media outlets, on a platform-agnostic basis, to market advertising inventory driven by content-based criteria rather than audience data alone. This is achieved preferably by text mining programming content in context and by interpreting the accompanying audio tracks, in text form, from a closed captioning system or from a real time voice recognition system or from any other source of video and/or program content. The present invention searches through opportunities for an advertiser, or advertising category, on any number of media outlets. The application of in context text mining to advertisement unit placement allows the advertiser to reach more viewers who are engaged and predisposed to receiving the advertiser's message.

### PRIORITY

This application hereby claims the benefit of provisional application No. 60/775,421, filed on Feb. 21, 2006.

### FIELD OF THE INVENTION

The present invention relates generally to a method and system for the optimizing of the value of the sale and purchase of certain video, audio or similar advertising inventory on a variety of electronic and digital distribution platforms, and more specifically relates to enabling media outlets and/or advertisers to easily place advertising in close proximity to co-related programming and/or editorial content, on short notice, prior to transmission time. The present invention is scaleable, that is, the advertiser can place a contextually related advertisement on one media outlet or, by virtue of the networked nature of the advertising opportunity, that same advertiser can also see all the advertising opportunities for correlated, contextually integrated advertising on the entire member network which are national or international in scope during any specified time period.

### BACKGROUND OF THE INVENTION

This invention should be understood with reference to the following study conducted in 2005 and 2006 by IBM. The study was entitled: The end of television as we know it. This study is a future industry perspective, authored by the IBM Institute for Business Value, 2006. Quoting the study, today audiences are becoming increasingly fragmented, splitting their time among a myriad of media choices, channels and platforms. For the last few decades, consumers have migrated to more specialized, niche content via cable and multichannel offerings. Now, with the growing availability of On-Demand, self-programming and search features, some experienced users are moving beyond niche to individualized viewing. With increasing competition from convergence players in television, telecommunications and the Internet, the industry is confronting unparalleled levels of complexity, dynamic change and pressure to innovate.

The study also notes that significant changes in both supply and demand are driving the industry to unparalleled levels of complexity and dynamic change and further indicates that television consumption is still on the rise. The one main shift from regular television in the 1980s to today is the number of channels a viewer has to choose from. In the 1980s, a viewer had only a select few channels to choose from which enabled advertisers to reach audiences much easier. Today, advertising on television is much more challenging in that viewers have a wide selection of channels and it is much harder for advertisers to capture a targeted and specific audience.

The study further discusses how viewers can now purchase programming and/or other video content ad-free or with very little advertising. This kind of advertisement free or limited advertising content is of concern to some advertisers because they may have reduced opportunities to place their advertisements on these kinds of distribution platforms.

By contrast, there is a great supply of advertising inventory, on traditional broadcast and cable TV networks. The large number of advertisements combined with other non-program material creates a great deal of clutter, which is objectionable to many viewers. As a result, many viewers utilize Digital Video Recorder and Personal Video Recorder technology to “record” and “replay” content and “zap through” (i.e. skip through) the advertisements. Many advertisers are very concerned about the clutter and “zapping” issue as it reduces the effectiveness of their advertising efforts. In fact, some advertising executives today place more faith in user-driven, On-Demand media verses broad based mass-appeal television advertising. Today, some On-Demand media are forcing viewers to watch advertising before, during, or after a program airs, prior to viewing the next program. This time slot is an especially good opportunity for the present invention described herein.

Another concern for television advertisers, mentioned in the study, is the impact that increased broadband Internet speeds and, in turn, consumers obtaining television directly over the Internet, will have on television advertising. Again, from the study, market changes in supply and demand are triggering the trial of new business models. As entertainment economist Harold Vogel explained, TV networks and content owners are trying to find a model that enables them to recapture some of the profitability that decreases when people watch television differently than they have historically. The present invention was created to help recapture advertising profitability in the future.

Currently, most advertising is placed through human interactions, including, but not limited to, negotiations, and also through some automated transactions involving sales representatives for media outlets, and media buyers for advertisers. Most transactional decisions are made on the basis of a price for reaching certain audiences that are exposed to specific programs, as determined by their size in numbers, age range, and gender as measured by industry ratings services. Most transactions occur months, weeks, and even days prior to the transmission of advertising. At many media outlets, there is a surplus of advertising inventory, far exceeding advertiser demand. This surplus results in a decline of advertising pricing. Additionally, because most advertising inventory is purchased on the basis of audience size and demographic characteristics, the advertising inventory has become highly commoditized.

The present invention overcomes many of the disadvantages inherent in the current methods of placing advertisements by reducing the number of human transactions required to place advertisements and by providing a new, more automated, and cost effective method for identifying and alerting media outlets and advertisers of upcoming advertising opportunities that are related to the advertiser's brands, products, services or the like. With the current processes, these particular advertising placements are generally missed opportunities as there is not a methodical and consistent process, with minimal human intervention, for identifying and exploiting these upcoming advertisement placement opportunities.

With the current systems, most of the opportunities for advertisers to buy advertising near programming/editorial content co-related to their brands, products, or services are missed. It is often too late, or too close to transmission time to exploit these opportunities. Further, it may be too late: to make a change to the media outlet's commercial log; to ensure possession of the actual advertising message for transmission; to move the previously scheduled advertisements to different positions within the content or to another day; for the sales representative and advertising buyers to communicate and then to consummate a mutually acceptable transaction; and when the media outlet becomes aware of the content opportunity. Furthermore, media outlets' sales and traffic departments that manage the commercial scheduling, rotation, and insertion process within the transmission schedule, as well as advertiser and/or advertising agency personnel, may not be available on short notice to effectuate the transaction.

There is a heavy tendency, in the currently accepted practice of advertising sales, to discount the pricing of commercial spot inventory. As a result, much of the advertising inventory has become highly commoditized, and the practice of discounting is generally considered normal.

The advertising sales representatives are typically compensated through some form of commission, and thus are driven to “make a sale” at virtually any price. This orientation precludes the salesperson from making their strongest efforts to achieve premium pricing for the sale of commercial inventory.

The complexity of functions performed by sales representatives are typically so great, that the amount of time and energy that would be necessary to exploit the multitude of these last minute content-related marketing opportunities is not practical or cost-effective under the current systems.

Under these current traffic systems, (i.e. media outlets' commercial scheduling, rotation, and insertion operations process), these “last minute” and frequent changes to the logs, and advertising insertion systems create chaos to an already high pressured and stressed operation.

Current practices do not provide for this type of last minute, and often after hours, decision-making at the advertiser and/or advertising agency level. Often budgets have already been spent and depleted, thus precluding advertisers from being able to exploit such opportunities. A great volume of these particular opportunities would be identified from hundreds of media outlets throughout the country, and thus can not be handled by the typical current structure of the advertisers' and/or advertising agencies' buying staff. Frequently, advertisers do not house an inventory of commercial messages at most media outlets. Current mass media outlets that transmit a linear program schedule from a central distribution point to their respective end-user audience are at a disadvantage to competing interactive and On-Demand media because Internet search-engines and On-Demand media can optimally position advertisers' marketing communications messages that are directly related to the subject being searched and/or to the programming/editorial content being exposed, while mass media outlets with linear distribution have not followed suit.

Furthermore, these mass media outlets that transmit a linear program schedule from a central distribution point to their respective end-user audience are at a competitive disadvantage because their audience measurements are only estimates, as generated by the ratings services. By contrast, Internet and On-Demand advertising are directly measurable, accountable, auditable and addressable.

The present invention overcomes the disadvantages of the related art by providing the features and functions described below.

### SUMMARY OF THE INVENTION

The present invention provides an intelligent automated system which enables media outlets to optimize the value of the sale and/or purchase of certain advertising inventory, by identifying virtually any programming and/or editorial content opportunity that is co-related to advertisers' brands, products and/or services. The system of the present invention searches through all related opportunities for a client advertiser, which occurs on any of the member media outlets. The member media outlets are all generally connected via a computer-based communications network, which is preferably, but not limited to, the Internet. The program content information may be continuously streamed or batched over to the programming content search engine.

The present invention is focused on television stations and cable interconnects, television networks (including, but not limited to, over the air, cable, satellite, and fiber optic services), and television syndicators, as well as other media, such as, but not limited to, satellite television, electronic newspapers and newsletters, the Internet, Internet Protocol Television, Podcasting, Webcasting, Netcasting, blogs, RSS (Really Simple Syndication), feeds, news, content, information feeds/aggregators, web sites, over the air and Internet radio stations, and satellite radio, among others.

The invention greatly reduces the cycle time between the identification of the opportunity for placing an advertisement and the actual appearance of the advertisement on the media. This reduction is achieved by a combination of information system automation and by reducing the steps required to arrive at a “go”, “no go” purchasing decision.

The present invention further provides media outlets and advertisers a means to exploit currently missed opportunities to sell and buy advertising near content that is contextually co-related to advertisers' brands, products, and/or services, even on very short notice.

Also, the present invention facilitates and incentivizes media outlets, regularly and easily, without disrupting their normal workflow and operations, to make late changes to their schedule logs and advertising scheduling, rotation and insertion systems.

The present invention also applies text mining to the domain of advertising spot placement, based on highly correlated content. This feature is an advancement allowing the advertiser to reach more viewers who are predisposed to receiving a commercial message relative to the advertiser's specific brands, products and/or services.

The method provided herein relieves the media outlet's sales representatives from regularly and manually tracking programming content and then trying to reach the advertiser and/or advertising agency buyers to attempt to complete a transaction. It further eliminates, from the transaction process, or at least significantly reduces, the emotions of unproductive sales representatives' motivations, thus preserving the opportunity to sell advertising inventory at the maximum possible price.

Another feature of the present invention is it offers advertisers the opportunity to place their brand, product and/or service marketing communications messages in a more conducive advertising environment, one in which the audience has a greater propensity to be receptive to their brand, product and/or service messages. This is particularly important in this era of extreme advertising clutter and minimum time separation between competitive advertiser commercials.

In addition, the present invention provides an automatic means of identifying any programming and/or editorial content that is appropriately targeted for a particular advertiser's brands, products and/or services in order to facilitate rapid communication of the advertising opportunity and consummation of the transaction.

Further provided is a method for moving excess advertising inventory by automatically placing those advertisements in a distributed fashion and spread out in time by the statistics of the occurrence of relevant broadcasting material. The distribution of the advertisement is a natural consequence/side-affect of the novel placement of advertisements based on programming content instead of traditional spot distribution methodologies.

Still another advantage of the present invention is that it provides advertisers with the capability to rapidly and easily identify and purchase virtually any and all co-related programming opportunities, which may be available for advertising messages. The system enables the advertisers to exploit these opportunities on hundreds of media outlets simultaneously and/or optionally for each media outlet individually. The present invention further provides advertisers with a justification to specifically allocate and reserve a content contingency budget to enable them to exploit such highly targeted advertising opportunities.

A significant advantage of the present invention is to enable media outlets to market advertising inventory on content-based criteria rather than on non-exact audience data estimates alone, which are subject to the vagaries and weaknesses of the respective audience measurement methodology. However, this technology may optionally be combined with audience measurement technology to considerably enhance the value of an advertising spot to a potential client.

The present invention further allows advertisers that may not otherwise consider or have the marketing resources, and/or advertising budget for a broad-based marketing or saturation approach advertising campaign, to instead choose to participate in a few highly focused and individuated content-correlated advertising opportunities. In addition, advertisers, who would typically never consider and/or could not afford such advertising, can produce an advertising message using a simple and cost-efficient “drop-in” template or templates, and then purchase only those rare content related opportunities which focus directly on their products, services, brands and/or business.

For example, and not by limitation, a small single-location shop, which sells only antique clocks, would only buy an advertisement in program or editorial content that deals with clock collecting and repair. Another example includes “Breaking News” events, such as but not limited to, severe weather warnings. In this and similar situations, an individualized “event-trigger” is created to alert the appropriate advertiser and/or advertisers to the immediate advertising opportunity. The advertiser makes the initial decision as to whether to place the advertising message in the “event related” content. The media outlet's verifier, preferably a person, then verifies the appropriateness of placing the advertising message in the “event related” content. The verifier is generally the first human involved in the advertisement placement process of the present invention. The role of the advertiser and verifier can optionally be reversed with the verifier providing a first review, depending on the specific situation. The verifier's role can be partially or fully automated and still be within the scope of the present invention.

A whole new and broader universe of organizations, using the present invention, now become potential advertisers. This is not based on the historical need to run broad-based advertising and marketing campaigns with many advertising exposures, but instead, only running advertising messages where viewers can be expected to have a predisposition to be receptive and have a personal interest in learning about the advertiser's products, services, brands and/or businesses.

A major benefit of the present invention is that advertisers who are already transmitting many advertising messages can use the system on either an automated and/or semi-automated basis, to redeploy the positions of their advertising messages so that the messages are transmitted in co-related programming or editorial content, and/or “event-alerted” content. In one preferred embodiment, major advertisers provide advertising messages via the Internet or dedicated network connection from a central advertising storage and distribution point, or a distributed network of distribution points, (i.e. an “Ad Farm”) to media outlets in one and/or many markets, and can have those advertising messages transmitted based upon “event alerts” or other similar criteria on an almost real time basis.

More specifically, what is provided herein is a method for optimizing the sale of audio and video commercial inventory comprising the steps of collecting advertising need information from advertisers, identifying programming content which is appropriately targeted for the need information, notifying advertisers of advertising opportunities related to the need information, and matching, by virtual identification, the need information with the programming content, such that the method provides a more cost-efficient and automated means to market and place commercial inventory.

The method further comprises a content and log acquisition subsystem responsible for acquisition of the programming content from sources. The sources are preferably, but not limited to, programming data from networks, syndicated programming suppliers, data from television newsroom scripts and/or international, national, regional or locally originated programming. The content and log acquisition subsystem is responsible for the acquisition of programming log data from media outlets. This programming log data is preferably, but not limited to, log spot availabilities, locations within shows, and/or pricing of inventory sold within a particular program.

Further provided is an advertiser subscription database data entry subsystem which has a user interface that accepts and validates data entries to facilitate the tracking of commercials and descriptive information regarding the commercials. The method also includes an intelligent search engine subsystem responsible for matching the advertiser's need information to highly correlated programming content. The intelligent search engine synthesizes this need information by using text mining techniques, such as but not limited to, context searching, semantic searching, matching based on concepts and topics, and/or machine learning algorithms. It further determines highly correlated programming content, resolves log availabilities, and detects programming content correlated to an advertiser subscription database. The search engine may additionally factor in audience demographics as an additional weighting factor as an optional feature when determining the match between sponsors advertising need and the suitability of the advertising spot.

The method additionally includes an advertiser interface subsystem implemented as, for example but not limited to, a secure web page such that the advertiser can log onto the advertiser interface subsystem. Also provided with the advertiser interface subsystem is an alerter program that is installed on an electronic device, such that the alerter program provides the advertiser with an alert message when an advertising opportunity is available.

The method further comprises the step of applying text mining to advertising spot placement, based on programming content. This text mining allows users to reach more advertisers who are predisposed to receiving a commercial message related to need information. Further provided is the step of using text mining and text analytics to explore unstructured text of the programming content, which provides a high degree of correlation between the need information and the programming content to thereby eliminate false positives. The invention further provides at least one machine learning algorithm that performs more efficiently as it learns from the opportunities that are accepted and rejected by the advertiser and verifier.

Overall, the method reduces the cycle time between identifying an advertising opportunity and the actual appearance of the advertisement and provides media outlets with a means to exploit programming content that is contextually co-related to an advertiser's need information.

### BRIEF DESCRIPTION OF THE FIGURES

FIG. 1 is a flow diagram of the method employed by the present invention.

FIG. 2 is a flow diagram of the modules employed by the present invention.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated method, and such further applications of the principles of the method illustrated herein, as would normally occur to persons skilled in the art to which the invention relates. The intent of the present invention is to cover all fields of audio, video, television, radio, cable, satellite, Internet or like advertising.

The present invention discloses an intelligent automated system which enables media outlets, such as: local television stations, for example, but not limited to, WRC and WTTG in Washington D.C.; television networks, including, but not limited to, over-the-air, cable, and satellite providers; program syndicators, such as, but not limited to, shows like Oprah, ET, and Dr. Phil; local cable systems, including, but not limited to, Comcast or Time Warner, which operate local systems and sell time locally on those systems; competition to cable systems, including but not limited to Fiber Optic Service, provided by Verizon Wireless; the method also addresses satellite television and video phone networks, such as DirecTV and VCAST®, provided respectively by DirecTV and by Verizon Wireless, to optimize the sale of specific commercial inventory, for example: local newscasts; local talk shows; network news programs, such as, but non limited to, Nightline or ABC News' World News Tonight; network shows, such as 60 Minutes, CSI or Good Morning America, Soap Operas, and The Late Show with David Letterman; syndicated shows, such as, but not limited to, Oprah, Wheel of Fortune, and Entertainment Tonight; or cable networks such as, but not limited to, CNN, USA, Food Network, and web based programming as might by provided via various Internet-based technologies, such as, but not limited to, Apple TV and iTunes, Bravotv.com, and various Internet-based technologies, such as, but not limited to, YouTube and MySpace, among others; by virtually identifying any programming and news content advertising opportunity that is in context and related to a particular advertiser's brands, products and/or services.

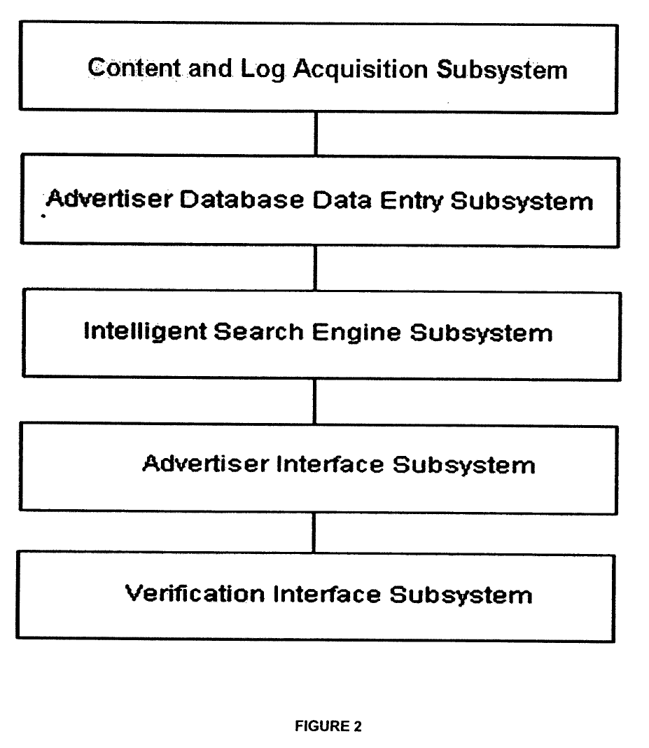

The intelligent automated system of the present invention is preferably comprised of several different interrelated subsystems and programs, which together accomplish the advertisement optimization (see generally FIG. 2). Each of these subsystems and many of the programs are described below.

Content and Log Acquisition Subsystem

The content and log acquisition subsystem of the present invention is responsible for the acquisition of content information from various sources, including but not limited to, programming data from networks, syndicated programming suppliers, data from television newsroom scripts and other locally originated programming, and similar data that may be available to describe the media's content. This subsystem of the present invention is also responsible for the acquisition of the outlet's programming log data, especially with regard to log spot availabilities, their locations within shows, and/or the pricing of inventory sold within any program.

This subsystem, however, does not compromise the integrity of the data's source. In order to meet these requirements, the content acquisition subsystem can optionally interface directly with any outside database and/or accept data input from the broadcast scheduling system(s) via a variety of “flat file” formats including, but not limited to, XML, EDI, traditional comma-delimited formats and/or custom formats using unstructured text.

The outside system providing the content data preferably exports the data in the format most convenient to the particular system. A specially written translation program and/or a commonly available utilities program converts the data format preferably from the external system format into an internal file format. As an example, and not by limitation, the translation programs and/or commonly available utilities programs incorporated into the present invention are preferably Oracle SQL*Loader® for use with an Oracle® Database, Microsoft® Data Transformation Services for use with a Microsoft® SQL Server Database, Microsoft® Access® data import capabilities and utility programs like Softpedia® Data Loader which supports Oracle®, Microsoft® Access, and/or FoxPro® Databases. A custom written program optionally can also be used for data import. The program can use standard database access methods, such as, Open DataBase Connectivity (ODBC) or Java DataBase Connectivity (JDBC). There can optionally exist as many separate data translation programs as needed, including those for special cases or custom systems in addition to the major traffic systems.

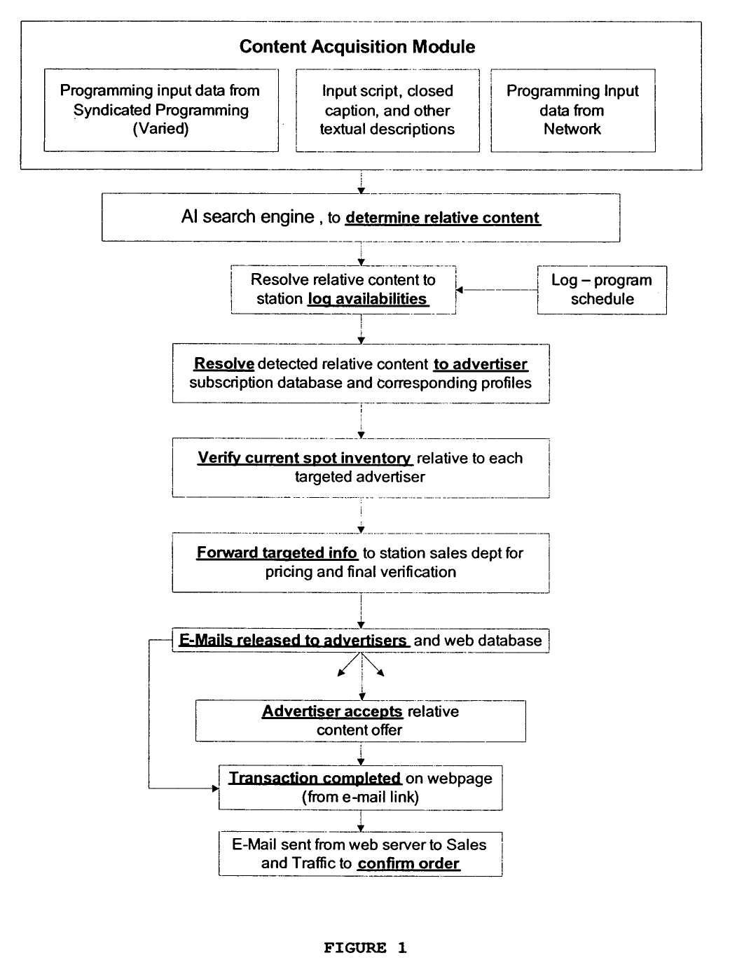

As an example and not by limitation, FIG. 1 shows a flow diagram of the method employed in a preferred embodiment of the present invention. The content and log acquisition subsystem is shown with several possible subcomponents all of which are responsible for the acquisition of content related information and/or program descriptive data, from various sources. Other possible sources of program descriptive data include, but are not limited to, closed caption text acquisition in real time, speech recognition from the audio portion in real time, video analysis or the like. The search engine may also optionally combine conventional audience data information as a weighting factor in the final determination of the suitability of the opportunity

This content related information and/or program descriptive data is to be supplied to the intelligent search engine subsystem. In turn, the intelligent search engine subsystem analyzes the content information for the purpose of determining its relative content. The relative content, log availabilities, and advertiser profiles are resolved, resulting in the matching of content relevant spot placement potential. The information is conveyed to the sales department for final review and then the advertiser is notified of the opportunity. The advertiser then is able to confirm or reject the opportunity via a web site or some other automated mechanism.

Advertiser Subscription Database Data Entry Subsystem

Advertisers participating in the method of the present invention can optionally have pre-recorded commercials that are specifically designated for a particular program and loaded on a special “server farm.” These commercials are then immediately available for airing as new content-targeted opportunities become available.

The present invention is generally focused towards television stations and cable interconnects, TV networks (both over the air and cable), and TV syndicators, as well as other media, such as, but not limited to, Satellite TV, Mobile Wireless TV, the Internet, IPTV, Podcasting, radio stations, and Satellite Radio, among others. However, the invention's applicability extends to other related fields and uses known to those skilled in the art.

The advertiser subscription database data entry subsystem consists of a user interface that accepts and validates data entries to facilitate the tracking of commercials and the descriptive information regarding a particular commercial.

Participating advertisers provide and/or specify the commercial inventory eligible for content optimized placement opportunities. The data gathered includes, but is not limited to, product or service category, product or service information, associated keywords, and a general description and/or any other information that may be pertinent to finding the best possible placement for a particular product, service or brand.

Intelligent Search Engine Subsystem

The intelligent search engine subsystem is one of the key features of the present invention and is responsible for matching the advertiser subscription inventory to the highly correlated content. The intelligent search engine synthesizes the information by using various text mining techniques, such as, but not limited to, context searching, semantic searching, matching based on concepts and related topics, and/or machine learning algorithms. The search engine determines the relative content, resolves log availabilities, and detects content correlated to the advertiser subscription database.

Relative content is determined using a combination of text mining technologies and text analytics to explore the unstructured text of the program information (similar to a “TV Guide” or online guide information), available scripts, such as, but not limited to, news scripts that may become available just prior to airtime, and other available textual data describing the program content, including the output from a real time voice recognition system derived from the program sound track. The textual content descriptive information is searched in multiple passes, using different text mining algorithms with each pass. Each pass narrows the content opportunities until only the highly correlated content is given as a final result. This multi-algorithmic approach leverages the advantages of each algorithm and provides the high degree of correlation necessary including, the elimination of “false positives” that would have occurred if only one algorithm was used. For example, if a primitive keyword search is used to narrow the content opportunities that search alone could yield a false positive for a heart medication advertisement if it found the phrase “He broke my heart.” However, if a second pass using a semantic and concept sensitive algorithm was then applied to this false positive opportunity, the context of the word “heart” would be deemed to be inappropriate for the heart medication advertiser. The search engine may also optionally combine this search procedure with conventional audience data measurement as a weighting factor if required.

Information for a particular advertiser, in the database, includes a description of the advertisement and/or a script from which various concepts are parsed and/or gleamed. Additional information about the advertisement/spot also includes a product or service category, such as, “automobile”, for example, which is configured with a variety of semantic search information that is shared with all advertisers associated with that particular product or service category. The text analytics of the advertiser, product, brand, and spot description are stored and then used as the basis for the text mining operations. This provides efficiency to the system from the aspect that the advertiser's text analytics only need to be determined once and stored or cached for comparison against the changing content.

For each text mining algorithm being used, only the potential content, ranked above a pre-determined level, is subjected to further analysis by subsequent text mining algorithms. The ranking threshold is initially configured, but can be changed by a set of learning algorithms. The concept search looks for related topics and concepts between the commercial and the potential content. Technology, such as but not limited to, IBM Unstructured Information Management Architecture (UIMA), OpenNLP (Open Source Projects related to Natural Language Processing) and/or General Architecture for Text Engineering (GATE), enables the search engine to perform text analytics and semantic searching. The multiple algorithms approach of concept searching, within the single search engine, results in highly correlated content-spot placement.

This search engine verifies the current inventory relative to each targeted advertiser and forwards the information to the advertiser. The notification to the advertiser is optionally an email, a text message, an alert program, other electronic transmission means, and/or the Verification Interface (see below). If suitable, the system automatically prices and sends the targeted spot opportunity as an alert to the appropriate advertiser or advertisers in the case of a more sophisticated “spot bidding” system. Targeted spot pricing is automatically generated based on customer-selectable parameters. For example, the average price of a spot airing, during the program, is computed “on-the-fly” and then multiplied by a customer-selectable premium multiplier. For example, a 50% premium is the suggested nominal increase for airing the spot adjacent to a targeted content area. Advertiser notifications are accomplished via email, text messages, cell phones, pagers, special alert software, other electronic transmission means and/or through the advertiser interface secure web portal as described in the Advertiser Interface Subsystem.

Another aspect of the method of the present invention is that it may optionally include machine learning algorithms that enable the system to perform more efficiently as it “learns” from the opportunities that are accepted and rejected by the advertiser and/or the verifier (as described below). Simply stated, once an opportunity has been identified, the advertiser has the ability to either accept or reject the opportunity. In either case, the search criteria that leads to this finding are credited with a “thumbs-up” or a “thumbs-down” (as discussed below). Over time, the search criterion, for a particular advertiser, becomes more efficient.

Another aspect of the present invention is to provide a method for moving excess advertising inventory by automatically placing those advertisements in a distributed fashion and spread out in time by the statistics of the occurrence of relevant broadcasting material. The distribution of the advertisement is a natural consequence/side-affect of the novel placement of advertisements based on programming content instead of traditional spot distribution methodologies.

Advertiser Interface Subsystem

The advertiser interface subsystem is primarily implemented as a secure web page that the advertiser must log into. Another optional aspect of the advertiser interface consists of a special alerter program that is installed on Windows-based PCs or other compatible workstation, including desktops, notebooks, cell phones, wireless PDAs, Blackberries or other generally accepted user interface. The alerter program provides the designated user with a special audio and/or visual alert message when a special opportunity is available.

Another aspect of the present invention is that an advertiser may participate in multiple advertisement optimizer system outlets. For example, and not by limitation, an advertiser may be seeking national exposure through local broadcast television stations across the nation for their heart medication and would want to be notified of any context appropriate local news programming related to heart health issues. The advertiser interface subsystem is further capable of receiving notifications from multiple advertisement optimizer systems.

Whether through the website, email, instant messaging, other electronic transmission means and/or an alert program(s), the advertiser can approve or reject the spot placement opportunity. Once approved, the “buy” order is conveyed to a person or system designated as the Verifier, as described below.

Verification Interface Subsystem

The verification interface subsystem provides the Verifier with the ability to review the correlated spot-content opportunity and to approve final verification that the subscribed advertiser's inventory and the correlated content are suitably matched to the goals of the advertiser. Additionally, the verification interface facilitates the consideration of appropriateness and taste standards. Once the opportunity is approved, the advertiser is preferably sent a confirmation via email, text message, alert program, website, other electronic transmission means, user interface program or the like. The media outlet's Traffic Department, which is responsible for the program schedule log, is also preferably notified via email, text message, alert program, other electronic transmission means, website, user interface program or the like.

If the Verifier deems the opportunity to not be appropriate, in addition to the appropriate notification to the advertiser, the system “learns” from the experience and applies two “thumbs down” to the search criteria. One “thumb down” negates the “thumbs up” given by the advertiser and a second “thumb down” discourages that combination of criteria.

The thumbs up/down system generally is a method of determining if a particular advertising opportunity satisfies pre-determined criteria or if the opportunity failed to satisfy the pre-determined criteria.
Two thumbs up generally means: I like everything about this advertising opportunity.
One thumb up generally means: I like something about this advertising opportunity.
Two thumbs down generally means: I do not like anything about this advertising opportunity.
One thumb down generally means: I do not like something about this advertising opportunity.

Other variations of the thumbs up/down system are also within the scope of the present invention, such as using a three or more thumbs up/down system. Other criteria rating systems, known to those skilled in the art are also within the scope of the present invention, including the option of pre-setting acceptance threshold by the buyer so that if the relevancy criteria for the advertisement are exceeded the advertisement is placed automatically without further human intervention. The threshold can also optionally be adjusted by the machine learning algorithm.

Financial Benefits and/or Advantages

The present invention increases revenues for media outlets, while simultaneously reducing certain operational costs relative to the insertion, deployment, and rotation of commercial advertising messages. The present invention also increases advertiser and/or advertising agency revenues, while simultaneously reducing certain operational costs, relative to the placement, deployment, insertion, and rotation of commercial advertising messages on media outlets. Therefore, the overall profitability of the media outlet is increased.

Media outlets generate additional and incremental revenues, from advertising placed through the use of the present invention, in many ways. First, media outlets, without the present invention, are unable to generate such advertising opportunities. Further, the present invention reduces advertising costs to advertisers by offering them a better means for targeting potential customers. Media outlets, that use the present invention, can charge a premium price, as opposed to a lower commoditized price for advertising placed adjacent to co-related programming or editorial content, because of its attractiveness and incremental value to advertisers and/or advertising agencies. Also, advertisers and/or advertising agencies are forced to make a very quick “Go”/“No Go” decision via electronic means, which is not subject to traditional negotiation and human interaction. Additionally, the present invention uses content based criteria rather than traditional audience metrics, which tends to commoditize the value of the commercial inventory being sold.

The present invention also generates additional revenues by optionally marketing commercial inventory within or adjacent to “Breaking News” events, which attracts larger than average audiences, on an almost instantaneous basis. The present invention additionally allows media outlets to now compete directly with Internet and other On-Demand advertising platforms that offer instantaneously targetable advertising opportunies, based on content that has not previously been available.

The media outlets further generate additional revenues from advertising placed through the present invention because groups of media outlets are aggregated, and co-related content opportunities are sold to advertisers across many markets, and across associated media distribution platforms. The invention induces advertisers and/or their advertising agencies to reserve special budgets for the specified purpose of advertising on short notice, in co-related programming and/or editorial content. The present invention also reduces the supply of available commercial inventory, for traditional negotiated sales, thereby driving up the advertising rates because of the laws of supply and demand.

Through the use of the present invention, media outlets reduce the costs of insertion, deployment, and rotation of spots because of the automated aspects of the present invention and its ability to be “traffic system-agnostic” interfacing with all commercial insertion systems.

The advertisers ultimately generate more sales through greater brand product, or service awareness for advertising placed, using the present invention, because the audience is more receptive to marketing messages aired in co-related programming or editorial content. Also, advertiser's commercial messages are now optionally placed in “Breaking News” events on an almost instantaneous basis, thereby, giving greater exposure to their marketing communications messages. These advertising messages are also optionally placed almost instantaneously into a single market or across many markets and distribution platforms to take advantage of content based, and “Breaking News” event opportunities.

With the automated nature of the present invention, the advertisers and/or advertising agency can reduce the cost and increase the operational efficiency of advertising planning, placement and insertion in one or many markets, and/or distribution platforms.

We claim:

1. A method for optimizing the sale of audio and video commercial inventory comprising the steps of:
collecting advertising need information from advertisers;
identifying programming content which is appropriately targeted for said need information; and,
matching said need information with said programming content;
whereby the method provides a more cost-efficient and automated means to market and place said commercial inventory.

2. The method of claim 1, further comprising the step of notifying said advertisers of advertising opportunities related to said need information.

3. The method of claim 1, wherein said matching is accomplished by virtual identification.

4. The method of claim 1, further comprising the step of providing a content and log acquisition subsystem responsible for acquisition of said programming content from a plurality of sources.

5. The method claim 4, wherein said plurality of sources are selected from the group consisting of programming data from networks, syndicated programming suppliers, data from television newsroom scripts, locally originated programming, radio, cable, fiber optic, and web based programming provided by Internet based technologies.

6. The method of claim 4, wherein said content and log acquisition subsystem is responsible for acquisition of programming log data from media outlets, wherein said programming log data is log spot availabilities, locations within shows, or pricing of inventory sold within a particular program.

7. The method of claim 1, further comprising the step of providing an advertiser subscription database data entry subsystem which comprises a user interface that accepts and validates data entries to facilitate tracking of commercials and descriptive information regarding said commercials.

8. The method of claim 1, further comprising the step of providing an intelligent search engine subsystem responsible for matching said need information to highly correlated said programming content, wherein said intelligent search engine synthesizes said need information by using a text mining technique selected from the group consisting of context searching, semantic searching, matching based on concepts and topics, and machine learning algorithms.

9. The method of claim 8, wherein said intelligent search engine determines said highly correlated programming content, resolves log availabilities, and detects said programming content correlated to an advertiser subscription database.

10. The method of claim 1, further comprising the step of providing an advertiser interface subsystem implemented as a secure web page, wherein said advertiser can log onto said advertiser interface subsystem.

11. The method of claim 10, further comprising the step of providing an alerter program installed on an electronic device, wherein said alerter program provides said advertiser with an alert message when an advertising opportunity is available.

12. The method of claim 1, further comprising the step of applying text mining to advertising spot placement, based on said programming content.

13. The method of claim 12, wherein the step of using said text mining allows said method to reach more said advertisers predisposed to receiving a commercial message related to said need information.

14. The method of claim 12, wherein said text mining synthesizes said need information using one of context searching, semantic searching, matching based on concepts and topics, and machine learning algorithms.

15. The method of claim 12, further comprising the step of using said text mining and text analytics to explore the unstructured text of said programming content.

16. The method of claim 15, wherein said text mining and said text analytics provide a high degree of correlation between said need information and said programming content to eliminate false positives.

17. The method of claim 15, wherein said text mining and said text analytics are combined with traditional audience data to determine a relevancy rating.

18. The method of claim 1, further comprising the step of providing at least one machine learning algorithm that performs more efficiently as it learns from the opportunities that are accepted and rejected by said advertiser and verifier.

19. The method of claim 18, wherein the verifier is a person.

20. The method of claim 18, wherein the verifier is an automated means which functions without human intervention.

21. The method of claim 1, wherein said method reduces the cycle time between identifying an advertising opportunity and the actual appearance of the advertisement.

22. The method of claim 1, further comprising the step of providing media outlets a means to exploit said programming content that is contextually co-related to said need information for a particular said advertiser.

23. A method for optimizing the sale of audio and video commercial inventory comprising the steps of:
identifying programming content which is appropriately targeted for advertiser need information; and,
matching said need information with said programming content;
whereby the method provides a more cost-efficient and automated means to market and place said commercial inventory.

24. The method of claim 23, further comprising the step of notifying advertisers of advertising opportunities related to said need information.

25. A method for optimizing the sale of audio and video inventory, for broadcast television, comprising the steps of:
identifying programming content which is appropriately targeted for advertiser need information;
matching said need information with said programming content; and,
providing at least one machine learning algorithm that performs more efficiently as it learns from the opportunities that are accepted and rejected by said advertiser and a verifier;
whereby the method provides a more cost-efficient and automated means to market and place said audio and video inventory.

26. The method of claim 25, further comprising the step of notifying advertisers of advertising opportunities related to said need information.
